(19) United States
(12) Patent Application Publication
(10) Pub. No.: US 2018/0129063 A1
(43) Pub. Date: May 10, 2018

(54) METHOD AND APPARATUS TO REDUCE LASER SPECKLE

(71) Applicant: DIGISLIDE PHOTONICS Pty Ltd, North Adelaide (AU)

(72) Inventor: Danny JUNG, North Adelaide (AU)

(21) Appl. No.: 15/804,844

(22) Filed: Nov. 6, 2017

(30) Foreign Application Priority Data
Nov. 4, 2016 (AU) 2016904500

(51) Int. Cl. G02B 27/48; G02B 17/00

(52) U.S. Cl. CPC G02B 27/48; G02B 17/004

(57) ABSTRACT

The present invention relates to a method and apparatus used for the reduction of laser speckle, and in particular, though not limited to, the projection of images. The method of reducing or supressing speckle of a divergent light beam from a light source includes directing an incoming divergent light beam at an optical element, the optical element having an entry face, a first pair of reflective surfaces and a second pair of reflective surfaces and an exit face, each pair of reflective surfaces having reflective surfaces positioned orthogonal to one another the distance between the first and second pair of reflective surfaces is

$$D > \frac{Cl}{2 n}$$

where D is the distance between the prism roof edges, Cl is the coherence length of the laser and n is the refractive index of the optical material or prism.

### FIELD OF THE INVENTION

The present invention relates to a method and apparatus used for the reduction of laser speckle, and in particular, though not limited to, the projection of images. The present invention further relates to coherent radiation sources generally, and describes a method and apparatus where a single laser light source is divided into multiple beams and each beam is delayed by more than the laser's coherence length.

### BACKGROUND OF THE INVENTION

Speckle is a phenomenon visible to the human eye or similar detector when a coherent light source such as a laser reflects off a textured surface forming an interference pattern. This pattern takes on a granular appearance and can be objectionable when a laser is used as a light source for imaging devices such as projectors.

Speckle has been a major obstacle for lasers being used for display systems like laser projectors and for other illumination purposes. Usually quantified by the parameter ‘speckle contrast’, a major task for designers and developers of laser projection systems has been to find some means of speckle contrast reduction to make displayed images ‘speckle free’.

Furthermore, as most traditional projection screens have a textured surface to reflect light over a wide angle back to the viewing audience, this has intensifies the visual experience of and viewing discomfort caused by speckle. As a result some cinema equipment suppliers and projection screen manufacturers are investing significant funds to develop and commercialise spectrally selective screen materials to create high contrast, light rejecting screens that can take advantage of the narrow primaries with existing RGB projectors.

With the need to increase light availability for projecting movies onto larger screens, and in particular to make projections sufficiently bright for 3D images; and to ensure low cost, and long life of projection equipment high powered lasers as a light source are considered optimum. Thus, speckle contrast reduction has become a bottleneck for the uptake of lasers for cinema projectors.

Researchers have, however, developed a number of effective means of virtually eliminating any visible speckle effect in state-of-the-art laser illuminated projector systems.

The most common method is a dynamic solution, with the use of rotating diffusers, which destroy the spatial coherence of the laser light. This method sees the diffuser creating continuous variations in the speckle pattern over time. When viewed, the average of the speckle patterns within the retention period of the eye is observed, lowering the perception of the speckle contrast. The stronger the diffuser and the faster the rotation, the lower the speckle contrast. However, a rotating diffuser for high power applications comes with its own unique problems associated with moving parts, wear and tear, cost and others pertaining to heat sinking as the moving parts generate additional heat, which adds to the heat the lasers are already producing—as it requires a relatively large diffuser; which in turn requires a higher power motor, which in itself can reduce the reliability of the speckle contrast reduction system.

Another method is to produce multiple speckle patterns simultaneously or at least within the integration time of the detector. The multiple speckle patterns average out thus reducing the contrast in the overall speckle. A single laser light source can be made to produce multiple speckle patterns if it is divided into a number of beams and the optical path of each beam is delayed by at least the laser's coherence length with respect to any other beam.

U.S. Pat. No. 7,586,959 describes a system to divide a laser source into multiple beams by way of the laser passing through differing lengths of blocks of glass where each block length difference is larger than the laser's coherence length.

U.S. Pat. No. 5,224,200 describes a system to reduce speckle by the use of two mirrors, one with a full mirror coating and the other with a partial mirror coating to divide the laser into multiple beams. Another method of dividing into multiple beams, but additional dichroic mirrors reduce robustness. The distance between the mirrors is such that each beam is incoherent with respect to any other beam.

Home and cinema theatre laser projection systems and hybrid designs have sought to reduce costs by not using three colours (Red, Green and Blue lasers) by employing a method using 2 blue lasers in conjunction with yellow phosphor which splits the blue light into red and green, to create the other wavelength of light. The aim has been to gain a higher colour space coverage, and to produce a highly efficient laser system. Other systems combine lasers and LEDs and phosphors.

Another approach has been to use a stationary diffuser, which reduces the heat sinking challenge—with, in some embodiments, the reflective diffuser being made on metal to provide some heat sinking or even liquid cooling. This approach requires using a stationary diffuser requires the laser beam to be scanned onto the diffuser surface; whilst keeping the output laser beam on the same optical axis while the beam is scanning, which involves moving parts with resultant issues of wear and tear, lessened robustness, and more components thus increasing the cost of manufacture, componentry and labour. As the diffuser is stationary and is obviously, non-rotating, the output will also be polarized in the same way as the input laser beam, when a polarization preserving diffuser is used.

One of the difficulties for researchers has been due to the optical characteristics of the speckle phenomenon, as it is difficult to make accurate and repeatable measurements. For example, the measured results may depend on the instrumentation used, the exposure time, distance of measurement and screen surface characteristics—and other factors not yet defined sufficiently to ensure consistent results.

This present invention seeks to address the concerns of the industry and to provide a static solution for the reduction of laser speckle that is cost effective, safe, and readily manufactured.

### SUMMARY OF THE INVENTION

According to the present invention, although this should not be seen as limiting the invention in any way, there is provided a static solution to laser speckle reduction, and describes a method and/or apparatus where a single laser light source is divided into multiple beams and each beam is delayed by more than the laser's coherence length.

According to the present invention, there is provided a method or apparatus of reducing or supressing speckle of a divergent light beam from a light source comprising directing an incoming divergent light beam at an optical element, the optical element having an entry face, a first pair of reflective surfaces and a second pair of reflective surfaces and an exit face, each pair of reflective surfaces having reflective surfaces positioned orthogonal to one another the distance between the first and second pair of reflective surfaces is

$$D > \frac{Cl}{2 n}$$

where D is the distance between the prism roof edges,
Cl is the coherence length of the laser and
n is the refractive index of the optical material or prism.

In preference, the plurality of sub-beams are directed out through the exit face.

In preference, the at least four reflective faces comprises a first pair and a second pair of reflective faces, each pair of reflective faces having a first and second reflective face with a 90° angle there between.

In preference, each of the first and second reflective faces with a 90° angle there between are adjacent faces.

In preference, each of the first and second reflective faces with a 90° angle there between are attached to each other.

In preference, the divergent light beam is a laser light beam.

In preference, the optical element is a prism.

In preference, the entry face and the exit face are orthogonal to each other.

In preference, the prism is coated.

In preference, the prism is un-coated.

In preference, the prism is coated on at least one surface with at least one coating selected from the group consisting of di-electric, UV-enhanced aluminium, protected aluminium, protected gold or protected silver.

In preference, the prism is a reflective prism.

In preference, a lens is used to focus the divergent light beam prior to entry into the optical element.

A further form of the invention is directed towards an apparatus for reducing or supressing speckle of a divergent light beam from a light source comprising directing an incoming divergent light beam at an optical element, the optical element having an entry face, a first pair of reflective surfaces and a second pair of reflective surfaces and an exit face, each pair of reflective surfaces having reflective surfaces positioned orthogonal to one another the distance between the first and second pair of reflective surfaces is

$$D > \frac{Cl}{2 n}$$

where D is the distance between the prism roof edges,
Cl is the coherence length of the laser and
n is the refractive index of the optical material or prism.

Advantageously the apparatus to achieve this can be a single static piece optical element such as a prism made from a suitable material and does not need any coatings to function.

Advantageously the polarisation of the laser is preserved.

### BRIEF DESCRIPTION OF THE DRAWINGS

By way of example, an embodiment of the invention is described more fully hereinafter with reference to the accompanying drawings, in which:

FIG. 1 is a first form of the present invention showing the optical element and beam divergence;

FIG. 2 is a is a far field map of the output of the coherence delay from the first form of the present invention indicating how the output beam is divided into multiple beams;

FIG. 3 is a second form of the present invention;

FIG. 4 is a third form of the present invention;

FIG. 5 is a schematic of the present invention in use in a projector.

### DESCRIPTION OF THE INVENTION

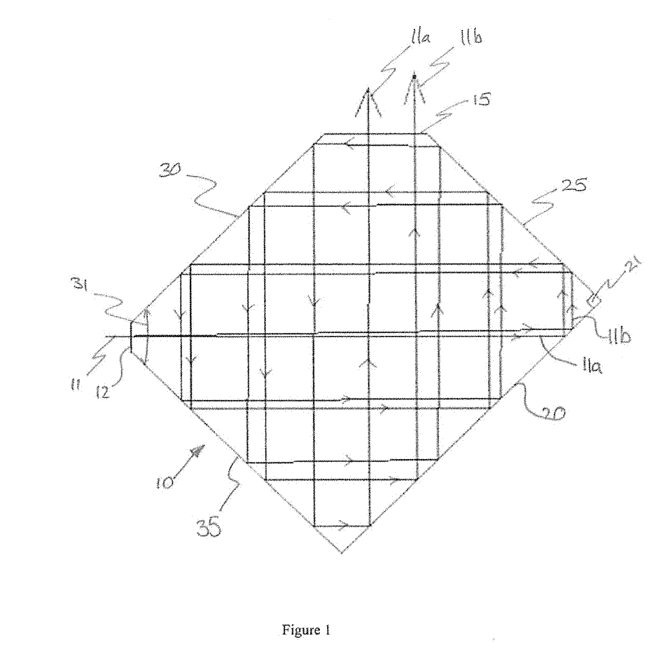

In one embodiment the optical element is a coherence delay prism 10 with six polished sides as in FIG. 1. The coherence delay prism 10 has an entry face 12, exit face 15, a first pair of reflective faces 20 and 25 respectively, with a 90° angle 21 between them, and a second pair of reflective surfaces 30 and 35 respectively, also with a 90° angle between them. In this embodiment, the coherence delay prism 10 can be made from any suitable optical material such as glass or plastic.

An input divergent light beam 11, which may be controlled by the use of a lens, enters the prism 10 at the entry face 12. The input divergent light beam 11 has a coherence length D being the propagation distance over which a coherent wave can maintain a specific degree of coherence. The beam 11 diverges, represented in FIG. 1 as beams paths 11a and 11b, as it passes through the prism 10 and commences multiple reflections from the first pair of reflective surfaces 2 and 3 and the second pair of reflective surfaces 4 and 5. Each pass between the first and second pair of reflective surfaces being a circuit.

With each circuit inside the prism 10, the divergent sub-beams 11a and 11b are slightly displaced from the previous path and the sub-beams 11a and 11b continue to diverge which thus results in a diameter of the beam increasing. The amount displacement of the divergent beam created by each circuit is determined by the offset of the first pair of reflective surfaces 20 and 25 and the second pair of reflective surfaces 30 and 35 with respect to the incident angle of the input light beam 11. After a number of circuits a part of the beams 11a and 11b diverge further apart and eventually beam 11a exits out through the exit face 15 while beam 11b continues for additional circuit until it also exits out through exit face 15. This process continues until all the light of the light beam 11 has exited the prism.

The size of the prism is determined by the coherence length of the laser in use. The distance between the first pair of reflective surfaces (20, 25) and second pair of reflective surfaces (30, 35) must satisfy the following equation;

$$D > \frac{Cl}{2 n}$$

where D is the distance between the prism roof edges,
Cl is the coherence length of the laser and
n is the refractive index of the optical material or prism.

The 90° angle 21 of the first pair of reflective surfaces (20, 25) and 90° angle 31 of the second pair of reflective surfaces (30, 35) must be accurate so as not to affect the divergence of the laser within the prism.

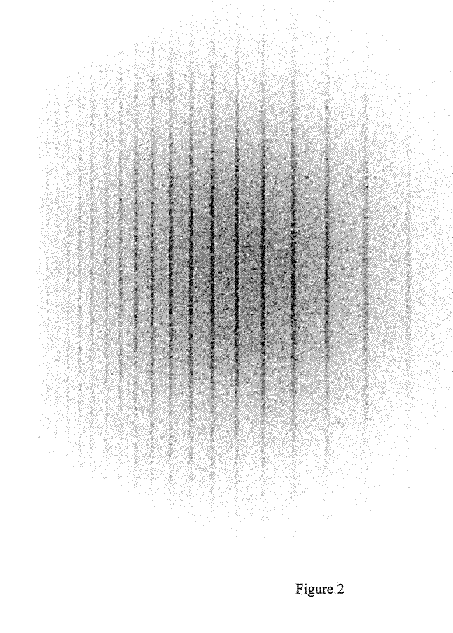

FIG. 2 is a far field map of the output of the coherence delay prism indicating how the output beam is divided into multiple beams. Each beam that exits the prism is incoherent with respect to any other beam because it has travelled a different distance in the prism. The offset of the first and second pair of reflective surfaces mentioned previously can be used to control the number of divisions the initial input beam undergoes when exiting the prism. The size of each output beam will be twice the offset of the first and second pair of reflective surfaces.

The height of the prism must be sufficient to accommodate the final diverging beam exit size. If this is undesirable then the top and bottom of the prism must also be polished to allow total internal reflection of the laser beam.

In a second embodiment of this invention the entry and exit surfaces of the prism could be fabricated to work at the Brewster angle to eliminate the requirement for antireflection coatings.

In a third embodiment of this invention the solid prism or optical element could be replaced with mirrors with the delay path working in air or gas.

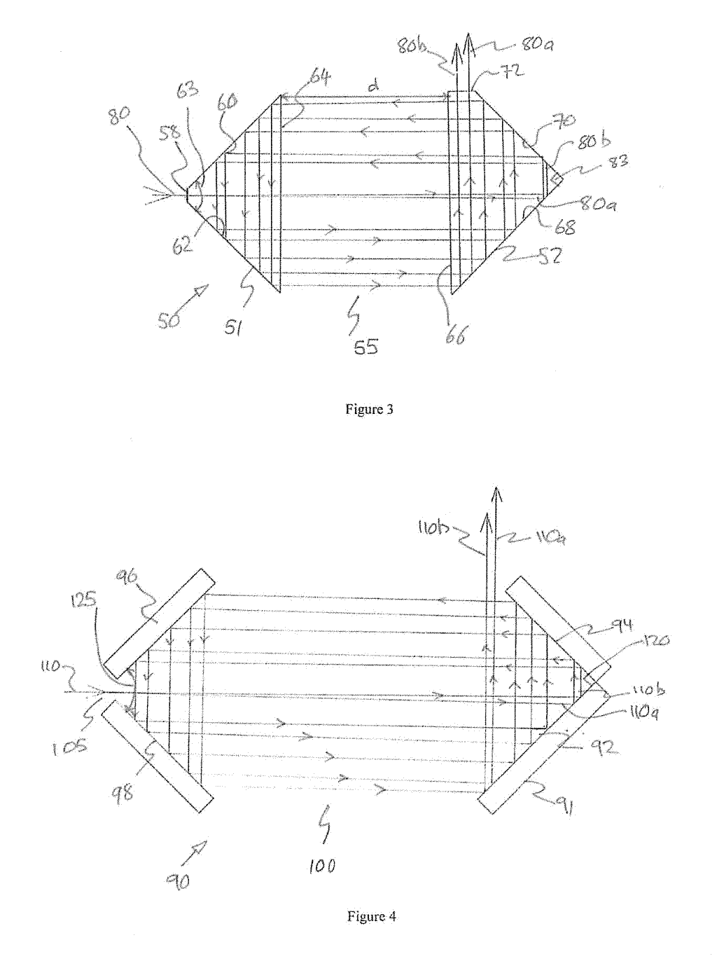

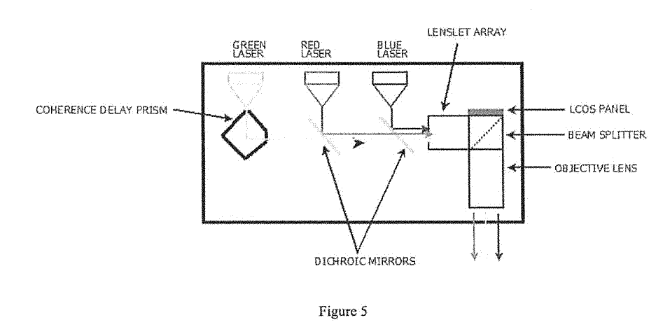

FIG. 3 shows a further form of the invention in which the optical element 50 is a pair of optical elements 51 and 52 with a space 55 separating them. Each of the optical elements 51 and 52 are prismatic, the first optical element having an entry face 58, a second pair of reflective surfaces (60, 62) at 90° to each other and an exit face 60. The second optical element 52 having an input face 66, a first pair of reflective surfaces (68, 70) at 90° to each other and an exit face 72.

An input divergent light beam 80, which may be controlled by the use of a lens, enters the first optical element 51 at the entry face 58. The input divergent light beam 80 has a coherence length D being the propagation distance over which a coherent wave can maintain a specific degree of coherence. The beam 80 diverges, represented in FIG. 3 as beams paths 80a and 80b, as it passes through the prism 51, out the exit face 64, through the space 55 and into the second optical element through entry face 66 and commences multiple reflections from the first pair of reflective surfaces 68, 70 and the second pair of reflective surfaces 60, 62. Each pass between the first and second pair of reflective surfaces of the separated optical elements 51 and 52 being a circuit.

With each circuit between the between the first and second pair of reflective surfaces of the separated optical elements 51 and 52, the divergent sub-beams 80a and 80b are slightly displaced from the previous path and the sub-beams 80a and 80b continue to diverge which thus results in a diameter of the beam increasing. The amount displacement of the divergent beam created by each circuit is determined by the offset of the first pair of reflective surfaces 68 and 70 and the second pair of reflective surfaces 60 and 62 with respect to the incident angle of the input light beam 80. After a number of circuits the beams 80a and 80b diverge further apart and eventually beam 80a exits out through the exit face 72 of the second optical element 52 while beam 80b continues for additional circuit until it also exits out through exit face 72. This process continues until all the light of the light beam 80 has exited the prism. The distance (d) between the two optical elements 51 and 52 can be varied according to requirements.

As with the optical element in FIG. 1, the distance between the first pair of reflective surfaces (68, 70) and second pair of reflective surfaces (60, 62) must satisfy the following equation;

$$D > \frac{Cl}{2 n}$$

where D is the distance between the prism roof edges,
Cl is the coherence length of the laser and
n is the refractive index of the optical material or prism.

The 90° angle 83 of the first pair of reflective surfaces (68, 70) and 90° angle 63 of the second pair of reflective surfaces (60, 62) must be accurate so as not to affect the divergence of the laser within the prism.

With respect to FIG. 4, a further form of the invention 90 is shown in which the optical element comprises two pairs of reflective mirrors, the first pair having reflective surfaces (92, 94) and the second pair having reflective surfaces (96, 98) with a space 100 there between.

An input divergent light beam 110, which may be controlled by the use of a lens, enters through opening 105 in the second reflective pair of reflective services (96, 98). The input divergent light beam 110 has a coherence length D being the propagation distance over which a coherent wave can maintain a specific degree of coherence. The beam 110 diverges, represented in FIG. 4 as beams paths 110a and 110b, through the space 100 and commences multiple reflections from the first pair of reflective surfaces (92, 94) and the second pair of reflective surfaces (96, 98). Each pass between the first and second pair of reflective surfaces being a circuit.

With each circuit the divergent sub-beams 110a and 110b are slightly displaced from the previous path and the sub-beams 110a and 110b continue to diverge which thus results in a diameter of the beam increasing. The amount displacement of the divergent beam created by each circuit is determined by the offset of the first pair of reflective surfaces 92 and 94 and the second pair of reflective surfaces 96 and 98 with respect to the incident angle of the input light beam 11. After a number of circuits a part of the beams 110a and 110b diverge further apart and eventually beam 110a exits the circuit while beam 110b continues for additional circuit until it also exits. This process continues until all the light of the light beam 11 has exited from the circuits.

As in the previously mentioned forms of the invention, the distance between the first pair of reflective surfaces (92, 94) and second pair of reflective surfaces (96, 98) must satisfy the following equation;

$$D > \frac{Cl}{2 n}$$

where D is the distance between the prism roof edges,
Cl is the coherence length of the laser and
n is the refractive index of the optical material or prism.

The 90° angle 120 of the first pair of reflective surfaces (92, 94) and 90° angle 125 of the second pair of reflective surfaces (96, 98) must be accurate so as not to affect the divergence of the laser within the prism. Note that in form shown in FIG. 4, the first pair of reflective surfaces (92, 94) are immediately adjacent to one another and may be joined to each other, whereas the second pair of reflective surfaces (96, 98) have an opening between them, which may be in the form of an opening or the reflective surfaces (96, 98) can be entirely separated from one another.

The output from the coherence delay prism can be shaped and controlled by additional optics and is used to illuminate a lens array, fly's eye array or diffuser to combine the multiple output beams. This in turn can be used to illuminate a light modulator such as a liquid crystal on silicon (lcos) panel in a projector. A projection lens is then used to project the image on the light modulator onto a viewing screen. The prism can be coated on at least one surface using conventional coatings known to those skilled in the art, such as UV-enhanced coatings, protected aluminium coatings, protected silver coatings or protected gold coatings.

In use, a prism was fabricated from BK7 glass to suit a 532 nm Spectralus laser with a 50 micron FWHM (full width at half maximum) beam output, which has a coherence length of approximately 3 mm. The size of the prism is 4.0×4.1 constructed as in FIGS. 1 and 4 mm high. The prism has an input aperture of 0.1 mm and an exit aperture of 0.3 mm. The angular error of the 90 degree corners were kept to within 10 arc seconds. A piece of glass with a ground surface was placed at the exit of the prism in order to produce a large amount of speckle when the light output from the prism was projected onto a screen. A small mirror that could be inserted between the laser and the prism and redirect the laser onto the glass diffuser bypassing the prism to compare the speckle pattern with and without the prism.

Using the above we were able to demonstrate a marked decrease in the apparent speckle of the projected output on the screen when the laser passed through the prism as compared to the bypassed projected output. A sheet of polariser film was also used to confirm that the light output maintained its polarisation to a high degree after passing through the prism.

This method can be used in any application where a laser is used for illumination and reduction in the speckle of the image is desirable.

The advantage of this invention is that a despeckled laser source is possible with a single static optical component that does not require any mirror or beamsplitting coatings.

1. A method of reducing or supressing speckle of a divergent light beam from a light source comprising directing an incoming divergent light beam at an optical element, the optical element having an entry face, a first pair of reflective surfaces and a second pair of reflective surfaces and an exit face, each pair of reflective surfaces having reflective surfaces positioned orthogonal to one another the distance between the first and second pair of reflective surfaces is
$$D > \frac{Cl}{2 n}$$
where D is the distance between the prism roof edges,
Cl is the coherence length of the laser and
n is the refractive index of the optical material or prism.

2. The method of claim 1, wherein the plurality of sub-beams are directed out through the exit face.

3. The method of claim 1, wherein the at least four reflective faces comprises a first pair and a second pair of reflective faces, each pair of reflective faces having a first and second reflective face with a 90° angle there between.

4. The method of claim 3, wherein each of the first and second reflective faces with a 90° angle there between are adjacent faces.

5. The method of claim 3, wherein each of the first and second reflective faces with a 90° angle there between are attached to each other.

6. The method of claim 1, wherein the divergent light beam is a laser light beam.

7. The method of claim 1, wherein the optical element is a prism.

8. The method of claim 1, wherein the entry face and the exit face are orthogonal to each other.

9. The method of claim 1, wherein the prism is coated.

10. The method of claim 1, wherein the prism is un-coated.

11. The method of claim 1, wherein the prism is coated on at least one surface with at least one coating selected from the group consisting of di-electric coating, UV-enhanced aluminium, protected aluminium, protected silver or protected gold.

12. The method of claim 1, wherein the prism is a reflective prism.

13. The method of claim 1, wherein a lens is used to focus the divergent light beam prior to entry into the optical element.

14. An apparatus for reducing or supressing speckle of a divergent light beam from a light source comprising directing an incoming divergent light beam at an optical element, the optical element having an entry face, a first pair of reflective surfaces and a second pair of reflective surfaces and an exit face, each pair of reflective surfaces having reflective surfaces positioned orthogonal to one another the distance between the first and second pair of reflective surfaces is
$$D > \frac{Cl}{2 n}$$
where D is the distance between the prism roof edges,
Cl is the coherence length of the laser and
n is the refractive index of the optical material or prism

15. The apparatus of claim 14, wherein the wherein the plurality of sub-beams are directed out through the exit face.

16. The method of claim 14, wherein the at least four reflective faces comprises a first pair and a second pair of reflective faces, each pair of reflective faces having a first and second reflective face with a 90° angle there between.

17. The method of claim 16, wherein each of the first and second reflective faces with a 90° angle there between are adjacent faces.

18. The method of claim 16, wherein each of the first and second reflective faces with a 90° angle there between are attached to each other.

19. The method of claim 14, wherein the divergent light beam is a laser light beam.

20. The method of claim 14, wherein the optical element is a prism.
